(19) United States
(12) Patent Application Publication
(10) Pub. No.: US 2018/0361266 A1
(43) Pub. Date: Dec. 20, 2018

(54) CONTENT DELIVERY SYSTEM WITH MODULAR TRAVEL STATION

(71) Applicant: Kids Go Co., Bainbridge Island, WA (US)

(72) Inventor: Justine Kanzawah Smith, Seattle, WA (US)

(21) Appl. No.: 16/029,148

(22) Filed: Jul. 6, 2018

Related U.S. Application Data
(63) Continuation of application No. 15/109,096, filed on Jun. 29, 2016, now abandoned.
(60) Provisional application No. 61/964,544, filed on Jan. 9, 2014.
(60) Provisional application No. 61/986,616, filed on Apr. 30, 2014.

(51) Int. Cl. A63H 33/00; B60N 3/10; A47B 23/00; B60N 3/00; B60N 2/26; A47G 23/06; A47D 3/00; A47B 23/04; A47B 23/06

(52) U.S. Cl. CPC A63H 33/00; A47B 2023/048; A47B 23/001; B60N 3/102; B60N 3/10; B60N 3/002; B60N 2/26; A63H 33/006; A47G 23/0633; A47G 23/0608; A47D 3/00; B60N 3/103; A47B 23/04; A47B 23/06; A47B 23/002; B60N 3/107

(57) ABSTRACT

A self-contained, modular, child-oriented travel center or travel kit is provided that includes a docking station having a portable table with a base having a recessed center and configured to sit sturdily around a child's lap, at least one insert configured to fit within the recessed center of the base, the insert configured to provide a child with an activity and being releasably connected to the base, and at least one slot formed in the base and configured to secure the base to a strap for a seat, lap restraint or tray. The modular inserts are configured as modular containers and the base has a plurality of recesses, each recess configured to removably and securely receive a modular container.

### CROSS REFERENCE TO RELATED APPLICATIONS

This application is a continuation of U.S. application Ser. No. 15/109,096 filed Jun. 29, 2016, which itself is a national stage application claiming the benefit under 35 U.S.C. § 371 of PCT Application No. PCT/US2015/010668 filed Jan. 8, 2015, which itself claims the benefit under 35 U.S.C. § 119(e) to U.S. Provisional Application No. 61/964,544 filed Jan. 9, 2014 and U.S. Provisional Application No. 61/986,616 filed Apr. 30, 2014, all of which applications are incorporated by reference herein in their entireties.

### FIELD OF THE INVENTION

The present disclosure is directed to content delivery systems, preferably of juvenile products and, more particularly, to a multi-purpose, modular, child-oriented, portable storage, entertainment, and educational docking and work station.

### BACKGROUND OF THE INVENTION

Everyday 128 million commuters spend a larger percentage of their commute time on family and personal business, and a lesser percentage of their time on school and church related commuting. The majority of families have no stay-at-home parent. People juggle work and family, struggling to meet their child needs, and hopefully—offer enrichment in the lives of their children. Parents spend hours prepping, packing, schlepping and cleaning for life on the move.

Of the pain points experienced by parents, the majority are stressed by mess and chaos of travel with children. Others feel they are often unsafe while driving as they are distracted from the road and trying to address children's demands at same time. Children are also exposed to the dangers of projectiles impacting them in an auto environment. Yet others experience guilt feels over the amount of time their children are forced to spend traveling in vehicles. A substantial number of parents and care givers find it difficult to meet a child's needs in the car.

Travel and commute time, in many ways, is “lost” time for parents and children. The on-the-road and travel environment makes it very challenging to provide both nutritious and enriching activities and to help children with a psychological sense of belonging.

Most juvenile products that have a short use life or “age compression” due to the user's rate of growth and development. Most children quickly outgrow their toys and amusement as well as educational activities. Although there have been many attempts to reduce the stress and preparation necessary to travel with children, these solutions have all failed to engage children of a variety of ages for a variety of activities. Children undergo rapid development, both physically and mentally, during their early years, and therefore a solution that works for a 2 year old child will likely not work for an 8 year old child. There exists, therefore, a need for a multi-purpose device that keeps and holds the attention of children of all ages while travelling, allowing parents to focus on driving safely.

There are a few offerings in the market place for simple travel tables. However, they provide few, if any, accessories or activities with limited flexibility. There is a need for a travel accessory that provides modularity, automatic upgrades, subscriptions or ongoing product relationship in order to address the foregoing problems.

### SUMMARY OF THE INVENTION

The present disclosure is directed to a content delivery system employing a portable table-top tray and multiple activity components. The tray is designed to integrate with car seats, strollers and high chairs, as well as a stand-alone work station in the form of a lap top device or supported over a user's lap with a stand or legs. The tray is designed to hold one or more interchangeable modular activity inserts filled with age-appropriate education, art and entertainment kits, mess-free and slip-free food containers, packaged foods, or an electronic tablet loaded movies, apps, and games, allowing parents to keep moving while their children's needs are being met at the highest level.

The “grab and go” modular inserts can be bought as a one off, licensed, or regularly updated through a subscription via an online consumer interface that automatically customizes inserts based upon a child's age, aptitudes, interests and nutritional needs. The present disclosure provides a high-quality, easy to use, sensibly designed, convenient solution to ongoing stress. It enables owners to be better parents and lessens the impact of a fast paced lifestyle on children.

The present disclosure includes an original product design that is totally portable and folds up or disassembles or both for easy transport in a carrying case. It has modular inserts for a wide range of activities and parenting needs. The line of replaceable inserts include, without limitation, a divided lunch box with a snap in or tethered spoon, fork, or other utensils, wet-wipe holder, beverage holder and insert space for either “pack your own” lunches or pre-made meals, an activities and games box, arts and creative inserts, and a digital tablet insert that contains a touch screen holder with long battery life, a safety cover and associated kids games, apps, narrated stories and digital coloring books that can be added and updated on an ongoing basis.

In accordance with one aspect of the present disclosure, a modular travel kit or travel center is provided that includes a portable table that has a base having a recessed center and configured to either be free standing or to rest on or preferably around a child's lap and supported on a seat, arm rests, or other surrounding surface. It further includes at least one insert configured to fit within the recessed center of the base, the at least one insert being configured to provide a child with an activity and being releasably connected to the base, and at least one slot formed in the base and configured to secure the base to a strap.

In accordance with another aspect of the present disclosure, the modular travel kit or travel center inserts are configured as modular containers and the base has a plurality of recesses, each recess configured to removably and securely receive a modular container.

In accordance with a further aspect of the present disclosure, the modular travel kit or travel center is configured so that each recess has a unique geometric shape and each corresponding modular container has a matching planform geometric shape to be slidably engaged within recess.

In accordance with still yet another aspect of the present disclosure, the modular travel kit or travel center has the base configured to be attached to at least one of a seat, a stroller, and a tray.

### BRIEF DESCRIPTION OF THE SEVERAL VIEWS OF THE DRAWINGS

The foregoing features and advantages of the present disclosure will be more readily appreciated as the same become better understood from the following detailed description when taken in conjunction with the accompanying drawings, wherein:

FIG. 1 is an isomeric view of a base for a modular children's tray with removable inserts formed in accordance with the present disclosure;

FIG. 2 shows modular inserts from FIG. 1;

FIG. 3 illustrates two light options formed in accordance with the present disclosure;

FIG. 4 is an isometric view of the base station formed in accordance with one aspect of the present disclosure;

FIG. 5 illustrates a sink with optional accessories formed in accordance with the present disclosure;

FIG. 6 illustrates a food tray with optional accessories formed in accordance with the present disclosure;

FIG. 7 illustrates a tech tray with optional accessories formed in accordance with the present disclosure;

FIG. 8 illustrates a play station formed in accordance with the present disclosure;

FIG. 9 illustrates a carrying bag for the modular system formed in accordance with the present disclosure;

FIG. 10 illustrates the interior of the carrying bag of FIG. 9 with modular system items stored therein in accordance with the present disclosure;

FIG. 11 illustrates one aspect of a Point-of-Purchase display formed in accordance with the present disclosure;

FIG. 12 illustrates one assembly approach for the modular system formed in accordance with the present disclosure;

FIG. 13 is an exploded view illustrating another assembly approach for the modular system formed in accordance with the present disclosure; and

FIG. 14 is an exploded view illustrating a further assembly approach for the modular system formed in accordance with the present disclosure.

### DETAILED DESCRIPTION OF THE INVENTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures or components or both associated with car seats, airline trays, pda's and tablets, arts and crafts, seat belts, and hook-and-loop fasteners have not been shown or described in order to avoid unnecessarily obscuring descriptions of the implementations.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one implementation” or “an implementation” means that a particular feature, structure, or characteristic described in connection with the implementation is included in at least one implementation. Thus, the appearance of the phrases “in one implementation” or “in an implementation” in various places throughout the specification are not necessarily all referring to the same implementation. Furthermore, the particular features, structures, or characteristics may be combined in any suitable manner in one or more implementations.

Generally, the present disclosure is directed to a modular, portable, content delivery system. In one representative implementation, the system includes a portable table, the table including a base, a table top on the base, the table top including a recessed center section and configured to be supported on or over a user's lap, at least one modular insert configured to fit within the recessed center section of the table top, the at least one modular insert configured to be releasably received in and attached to the table top, and a plurality of activity kits, each activity kit configured to be contained within the at least one modular insert.

In accordance with various aspects of the present disclosure, the system includes a plurality of accessories and the base includes a skirt, the skirt having a plurality of attachment points structured to enable releasable attachment of the plurality of accessories as described more fully below in connection with the figures. Ideally a tether is provided that is configured to attach one or more accessories to one of the plurality of attachment points on the skirt. Such accessories can include eating utensils, such as a spoon or fork, or a writing utensil, a towel, or known hand-holdable items.

Preferably the table top has a plurality of container recesses and the system further includes a plurality of modular containers as described more fully below. Briefly, each container is sized and shaped to be removably and securely received within a respective modular container recess in the table top. In accordance with one aspect of the present disclosure, each modular container recess of the plurality of modular container recesses has a unique geometric shape and each corresponding modular container has a matching geometric shape that is sized to be slidably engaged within the respective modular container recess.

The base may be configured to be attached to at least one of a seat, a stroller, and a tray. At least one slot may be formed in the base and configured to receive a security strap. In most implementations, the base is a one-piece molded shell and formed from non-toxic, solid but flexible, washable, solvent and dishwasher safe plastic material.

A carrying case is provided that is sized and shaped to receive and hold the portable table and at least one activity kit. For ease of storage and transport, the skirt is configured to be foldable.

The at least one modular insert and the plurality of modular containers can be configured to be customizable by a user to enable a user to select contents for the modular inserts.

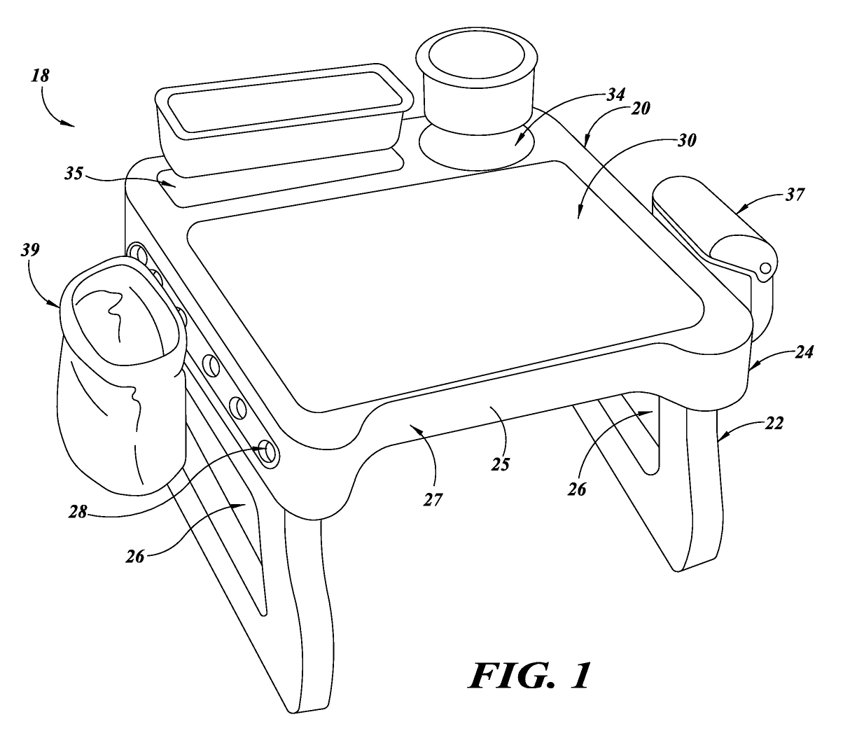

Referring initially to FIGS. 1-4, shown therein is a modular system 18 that includes a modular children's tray 20 having a base 22 that is designed to fit on or around the lap of a child (not shown). The modular children's tray 20 is a portable table-top travelling environment that integrates with car seats, strollers, and high chairs or functions solo. The modular children's tray 20 is designed to hold replaceable activity cases filled with education kits, mess and slip-free food containers, packaged foods, and entertainment devices such as a tablet with movies, apps, and games. The variety of inserts and customizability of the modular children's tray 20 allows parents to safely keep moving while their child's needs are being met.

The base 22 is generally composed of molded polypropylene, foam or any related material composition to be formed in the shape of a rectangular, rounded edge platform. The top of the base 22 forms a table top that contains a recessed insert well 30 to accommodate fitted insert modules and components for various defined purposes. The base 22 is generally designed as a one-piece molded shell and formed from non-toxic, solid but flexible, washable, solvent and dishwasher safe plastic material(s).

The base 22 includes a foundation skirt 24 containing a shaped perimeter and insert slots 26 that provide attach points for automobile and aircraft seat-belts, child stroller and car-seat restraints, and accessory lap straps (not shown) that may be threaded through the base and secured in a typical fashion, such as with buckles, snaps, hook-and-loop fasteners and the like. In one implementation, the skirt 24 includes legs that can be integrally formed therewith or removable therefrom, the legs sized and shaped to support the base over or on top of the lap of a user.

The skirt 24 ideally contains a leg well 25 carved out of the front wall 27 of the skirt. The leg well 25 allows the base 22 to rest securely and stably around the lap of a child while maintaining a horizontal orientation.

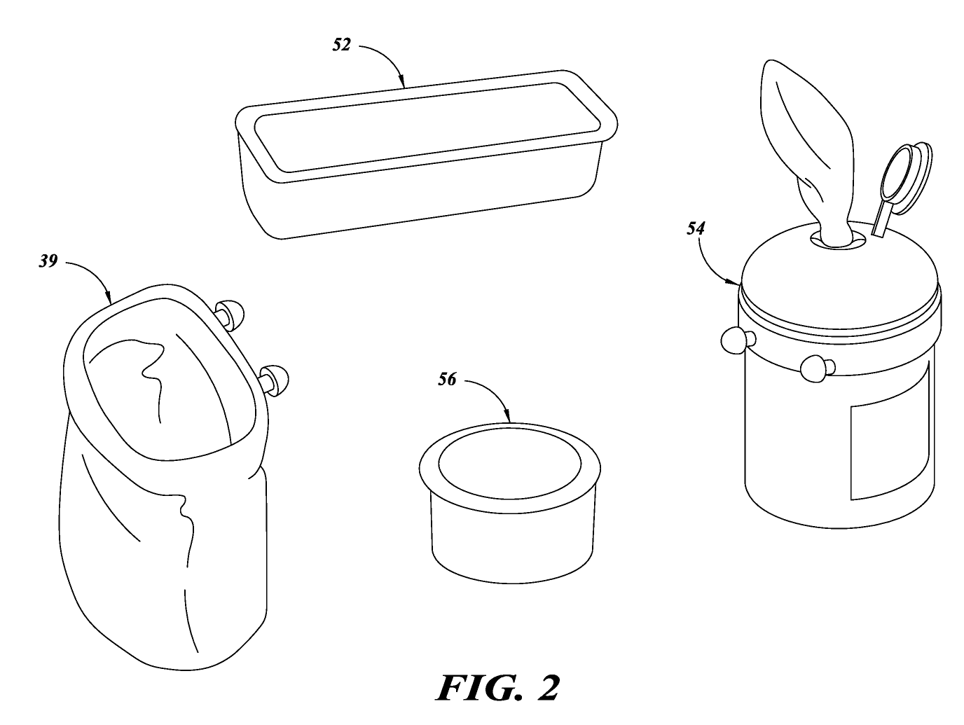

The skirt 24 is formed to act as a support so that the base may rest squarely on a flat surface such as a table or that various modular inserts (shown in FIGS. 2 and 5-8) may be snapped into place, utilizing the inherent flexible nature of the plastic or foams. Such foundation inserts may include, but are not limited to, a soft, pliable ‘bean bag’ or squishy base for uneven surfaces and laps, tracks to snap the base into a standard highchair tray track, and other suitable attachment systems.

The upper surface, i.e., table top, of the base device is comprised of a deep central recess forming the insert well 30. The insert well 30 is shaped to fit any of several modular inserts 50 containing an activity kit, with which a user, preferably a child, will interact. The perimeter of this recess 30 preferably includes shaped depressions or modular insert recesses 28 in which various activity and user care inserts may be snapped or fitted into place. These recesses 28 may be sized and shaped as a cup holder 34, and a tray insert area 35. An accessory illuminating lamp 37 for night use is snapped into the skirt 24 on either side, i.e., left side or right side as seen by the user, and a battery recess can be provided for electrically powered activity inserts such as tablet and gaming devices. Alternative implementations may include trash receptacle attachment 39, a headphone/iPod or music player attachment, and remote activator so that parents or adults can control content on multi-media devices remotely (such as starting a movie for a child or restarting a game via a cell phone app or other digital trigger.

Vertical areas of the side skirt 24 may be formed to enable the attachment of accessory devices at attachment points, such as containers, cup and bottle holders and vendor provided aftermarket products. Accessory devices may attach using hook and loop style fasteners, mushroom plugs, or any other suitable fastening method that enables attachment and removal of the accessory devices, preferably only by an adult, but it may allow a child to attach and remove devices if so desired. FIG. 1 shows the openings 28 of a circular shape configured to receive mushroom plugs.

Alternative implementations of the base 22 includes a three-sided variation with folding corners for easy pack up and travel or for rolling or even bended options. Optionally, a puzzle-piece assembly can be used where the sides are easily removed and reinserted via a friction fit.

FIG. 2 also shows containers that may be placed into the insert well 30. These include a tray 52, a dispenser of hand wipes 54, a trash bag 39, and a cup 56. They are sized and shaped to fit within insert wells that have a matching size and shape. This will function as an activity itself for the user as well as ensure certain containers are in the proper location, such as for safety, ease of use, and the like.

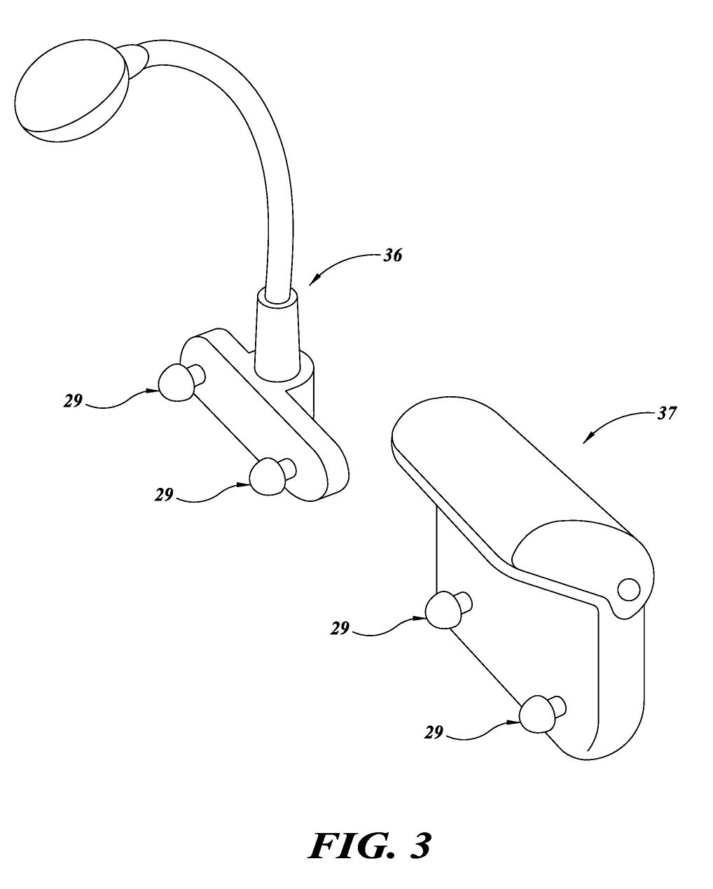

FIG. 3 illustrates two versions of attachable lights 36 and 37. These lights 36, 37 include at least one and preferably two mushroom plugs 29 sized and shaped to be press-fit into the corresponding opening 28

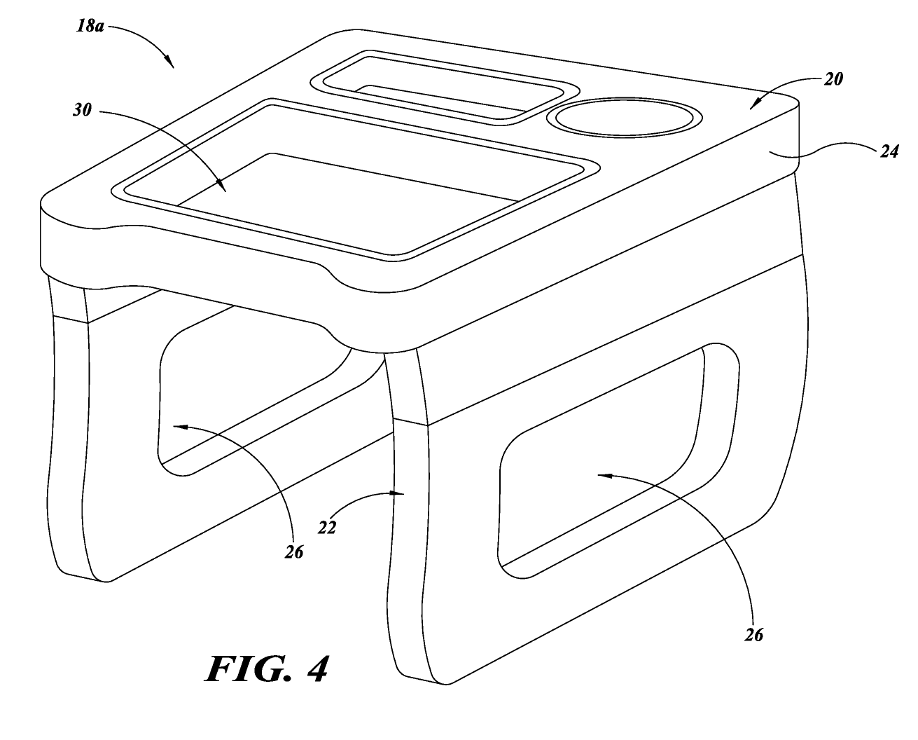

FIG. 4 illustrates a lap top unit 18a without the accessories and optional mounting holes in the skirt 24.

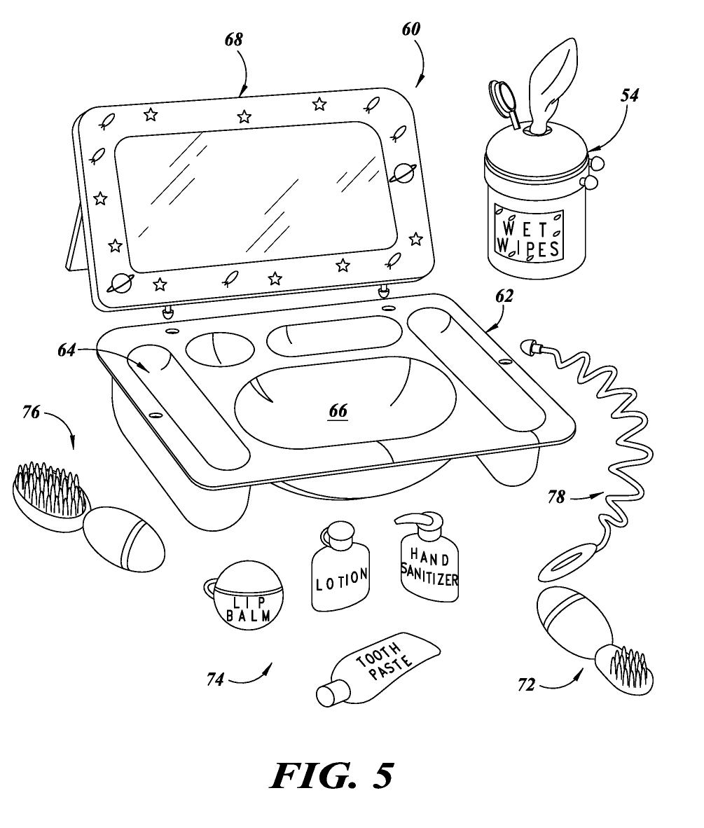

FIG. 5 illustrates a modular hygiene kit insert that will include items such as a pliable toothbrush, spit sink, wet wipes, mirror, brush or comb and other care items. Included is a sink insert 60 that has a sink base 62 having a variety of shaped recesses 64 and a sink 66. A detachable mirror 68 attaches to the far side of the base 62 using mushroom-style plugs. Accessories include a brush 70, toothbrush 72, various toiletries 74 such as lotions and toothpaste, a hair brush 76, and the previous hand wipes 54. A coiled flexible filament 78 can be attached to the base 62 and then to various items or accessories at the free end.

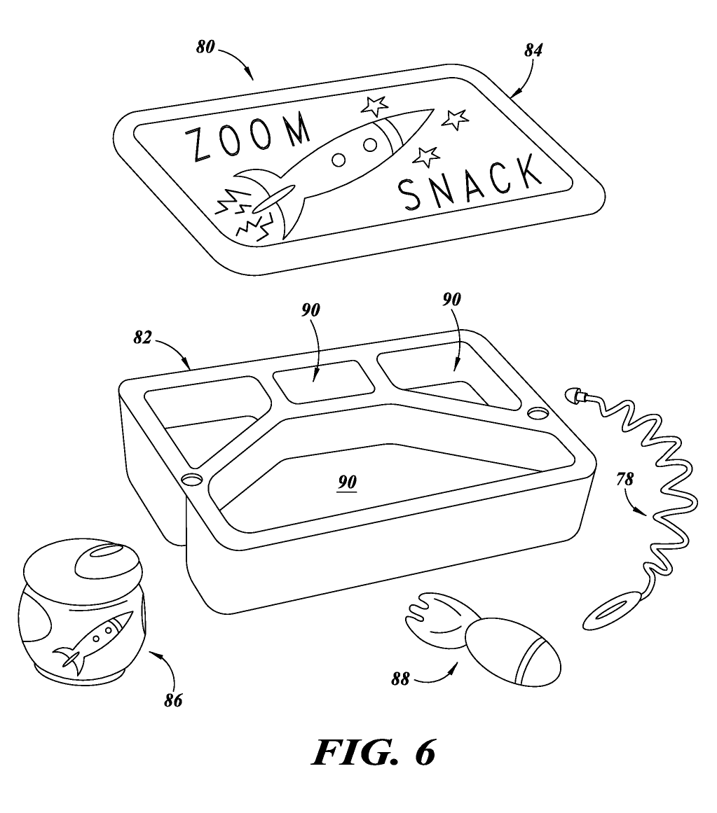

FIG. 6 illustrates a food insert module 80 having a food insert base 82 and lid 84 that is attachable to the base, such as with a snap fit, hinged lid, or friction fit. Accessories include a cup 86 and fork 88 and other utensils (not shown), such as a spoon as well as a tether 78 of silicon, fabric or other pliable for that may be used to attach utensils, cups, or other accessories to support the “drop-free” solution. The food inserts include options of containing disposable, non-disposable, perishable and non-perishable goods. Food inserts optionally include a removable insert liner that is easily washable and dishwasher safe, heating and cooling elements, and removable separate food containers. Food insert bases generally contain within them a variety of small, compartmentalized recesses 90 to keep foods and utensils separated from one another.

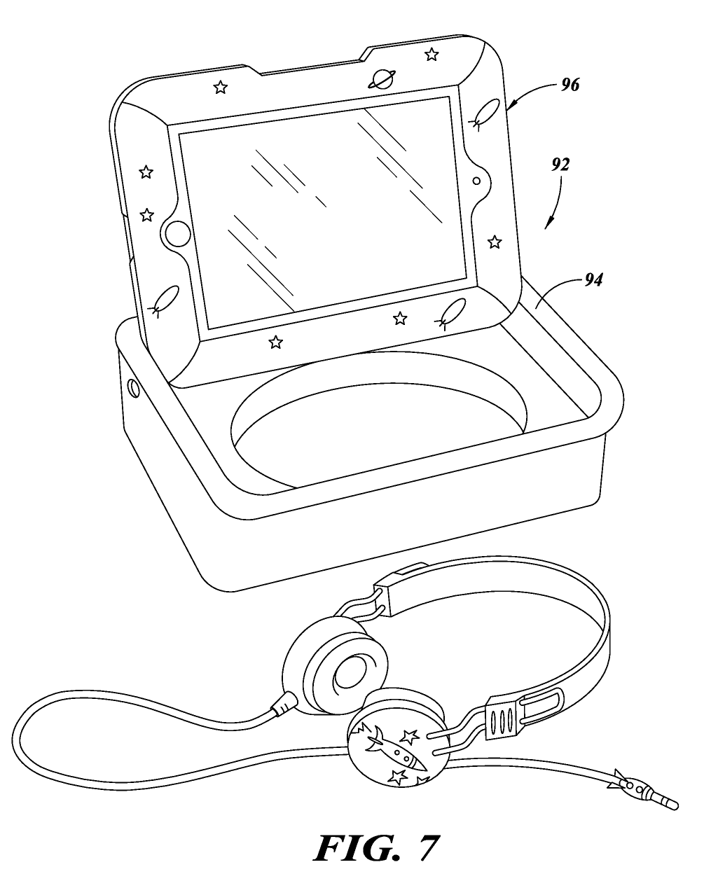

Digital inserts 92 and applications include an electronic screen 93 and speaker (not shown) configured to display movie playback games and educational applications, music, on-line streaming, digital coloring-books, and other customized digital content. As shown in FIG. 7, the insert 92 includes a base 94 sized and shaped to hold the digital and electronic devices and a lid 96 that incorporates the screen 93. A pair of headsets 98 is shown as one optional accessory, and additional accessories include a long, life battery and charging system and an external remote or digital application to control tablet content.

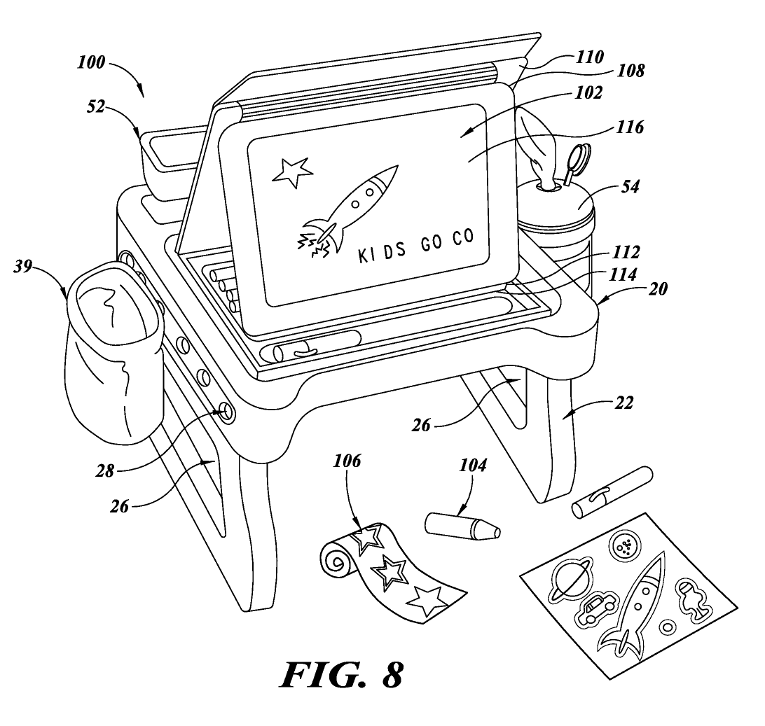

FIG. 8 illustrates an activity and entertainment module 100 that contains or is structured to contain a wide range of everyday arts and crafts, drawing, science and other learning games and entertainment. Shown in FIG. 8 is a writing board 102, such as a white board, and one or more writing utensils 104 and stickers 106. The writing board 102 is configured to have a top edge 108 pivotally attached to a lid 110 of the module 100. The writing board 100 is stored under the lid 110 in a stored configuration when the lid 110 is closed and lying flat on the module 100. It is configured to fold out from the lid 110 with an opposing edge 112 supported on a lip 114 or in a recess on the module 100 so that a writing face 116 of the writing board 102 is supported at an acute angle relative to a plane of the base. In other words, the writing face 116 is designed to face the user at an angle when deployed from the module 100.

In accordance with one aspect of the present disclosure the insert pieces will all be designed with soft rounded edges, made of soft, lightweight and flexible materials and be tethered to the base table, all with the intent of removing the risk of injury from projectiles upon any impact, a current transportation hazard.

The modular inserts can be bought as a single item or regularly updated through a subscription service plan. Users who obtain inserts through a subscription service may utilize an online consumer interface that automatically customizes updates based upon age, aptitude, interests and nutritional needs. The inserts are modular in nature, enabling parents to quickly and easily pack, deploy, utilize, and collect. Each modular insert is a stand-alone item that includes everything necessary for full use and enjoyment of the activity or experience. Contents of the modular inserts are targeted for particular age groups or experience levels of the activity.

In accordance with one aspect of the present disclosure, the modular inserts may be customized by the user in order to adapt to and evolve with a child, allowing for ongoing customization and a long use-life, giving the purchaser a better value for their money. Selectable contents can be made available through existing distribution channels, including on-line purchases, subscription-based ordering, and the like.

Unlike most juvenile products that have a short use life or “age compression” due to the users rate of growth and development, the child does not outgrow the modular inserts. Rather, the modular inserts “grow” and evolve with the child. Once age, interests, and activities are recorded, regular inserts which appeal to the child and family based upon their interests may be automatically calculated and offered through the ongoing subscription service.

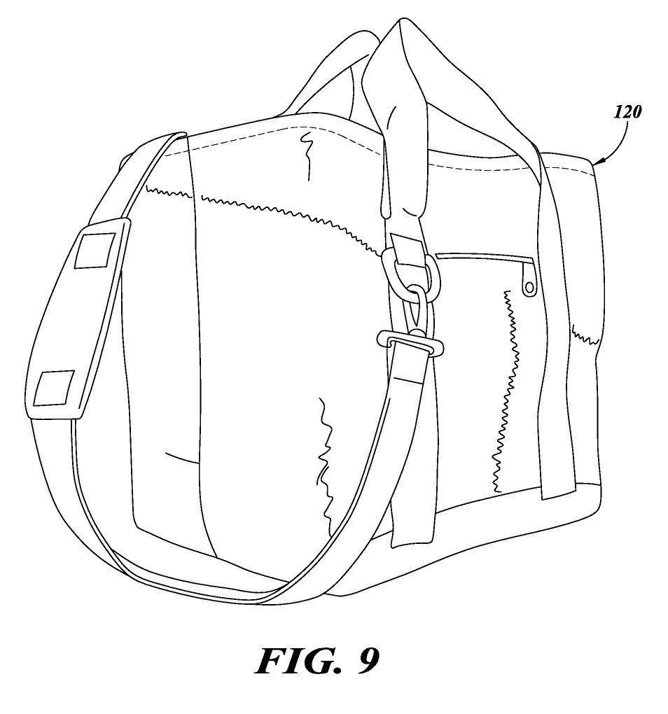

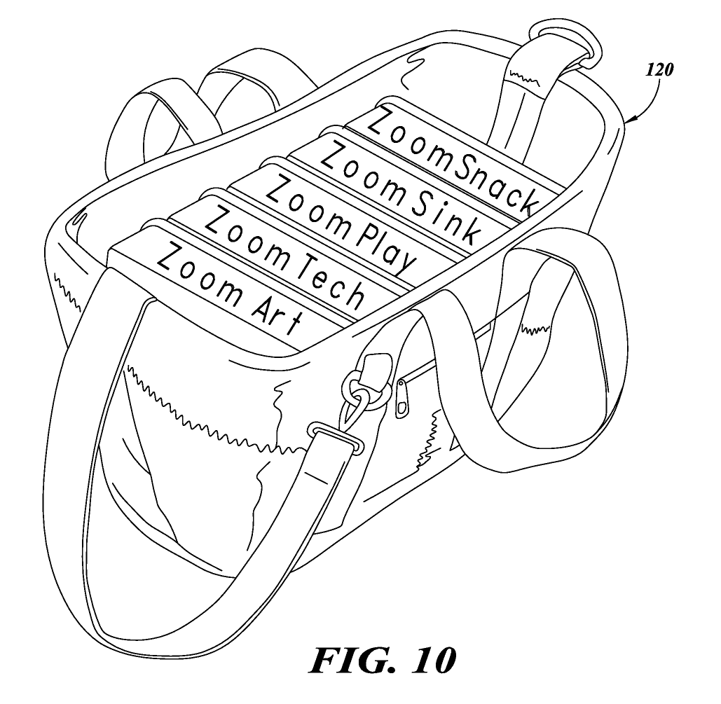

FIGS. 9 and 10 show a carrying case 120 for the modular children's tray. For example, the modular children's tray 20 folds up for easy transport in the carrying case 120 It may be used in a variety of settings, including an automobile, stroller, high-chair, airplanes, and public transportation. The insert slots 26 may have optional straps so that the base 22 can be secured to any structure. The case 120 also is sized and shaped to carry each modular insert in its own storage container. Other custom carrying solutions such as a back-back, belt or other innovation may be developed.

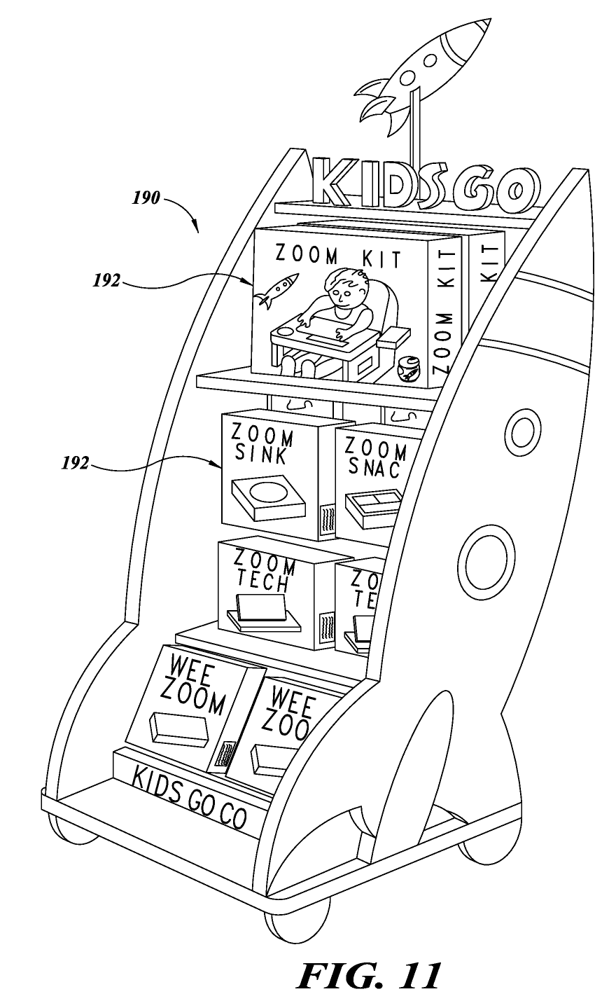

FIG. 11 shows an optional Point-of-Purchase display 190 for various modular inserts 192. This display 190 is for use in traditional brick-and-mortar stores where customers can observe, inspect, and select one or more modular inserts 192 for purchase.

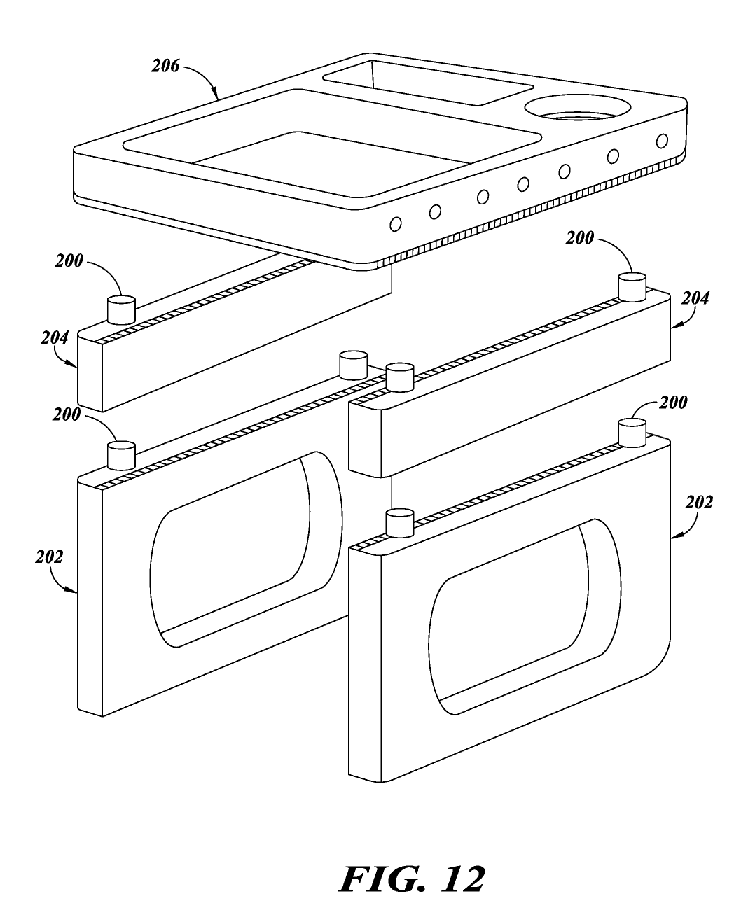

FIG. 12 illustrates one assembly method using fitted posts 200 and corresponding openings (not shown) for attaching legs 202 to a skirt 204 and the skirt 204 to the base 206.

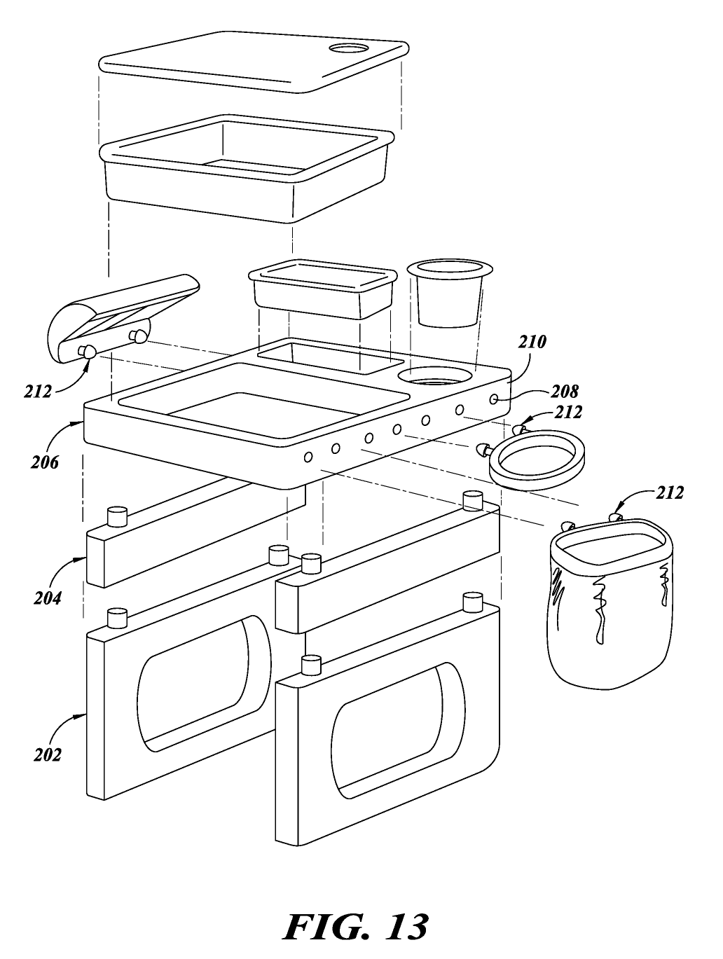

FIG. 13 illustrates another method of assembly in accordance with the present disclosure in which the base 206 from FIG. 12 has circular openings 208 in a side 210 of the base 206 to receive mushroom-style plugs 212 on the various accessories previously described. This configuration enables easy disassembly, storage, transport, and assembly of the system.

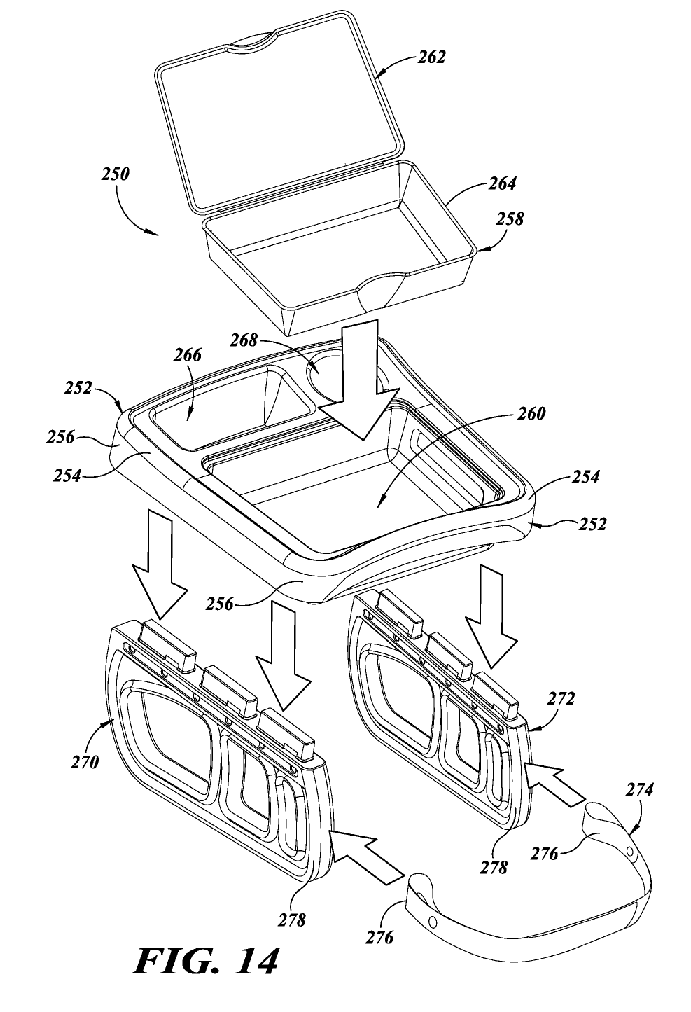

Finally, FIG. 14 illustrates a further implementation of a content delivery system 250 formed in accordance with the present disclosure in which a tabletop 252 and integral skirt 254 around at least the sides of the table top 252 and, preferably around the entire perimeter of the table top 252 has soft, rounded and curved horizontal edges and vertical edges 256 throughout. The system 250 includes a central modular container or insert 258 having a substantially rectangular planform shape, although other shapes may be used. It is sized and shaped to be slidably and preferably tightly fit into a marching recess 260 in the table top 252. The container 258 includes a hingedly attached cover 262 that can be securely snapped in place using any known method of securement to the bottom portion 264. Additional wells 266, 268 are provided having a different geometric planform shape for receiving containers or activity kits of the same shape. As shown in FIG. 14, this illustrates the placement of the insert 258 into the deep recess 260 tabletop 252. It also illustrates a method of attaching two legs or side supports 270, 272 to the tabletop 252 base via a rectangle, snap-in assembly system having a male portion 274 configured to be received with a tight fit into a corresponding female portion (not shown) in a bottom surface of the table top 252. This illustrates the ease of assembly, disassembly, and modularity of the system. It also demonstrates the ability to use the inserts and tabletop either autonomously or together as a system.

Additionally, FIG. 14 shows a retaining member in the form of a basic webbed strap attachment 274 wherein the tabletop 252 can be attached via the side supports 270, 272 around or under a user's body for increased stability and to prohibit the tabletop 252 from falling or being thrown off. As shown, the strap 274 has releasable loops 276 at each end for attachment to a structural member 278 of each side support 270, 272. The strap 274 is designed to be placed, for example, around the user's lower back, thus holding the entire system 250 in front of the user.

The content delivery system of the present disclosure addresses the environment of driver distraction by encouraging children to remain properly seated in their car seats and boosters for longer periods of time allowing those safety devices to be more effective. The child's more consistent engagement relieves driver distraction dangers as the activity kits and “No-drop” tethering allow children to be more self-sufficient in a mobile environment thereby allowing drivers to focus on the road. The product and system addresses injury via projectiles with a design using soft rounded edges, lightweight materials, and steering away from any sharp points, hard or heavyweight materials. The tethering and securing of items also reduces the potential of flyaway items, further reducing risk in an impact scenario.

Potential Use Case Scenarios for implementations of the present disclosure that are not currently met or served by any existing product are listed below. In these possible use case scenarios, a product employing the teachings of the present disclosure can be used as a stand-alone table, with or without the activity inserts or combined:
Doctor's Office: Table and activity inserts work perfectly on a doctor's table while a child waits for the doctor or for a sibling sitting in the chair during an exam.
Air-Travel: Fits easily around a lap and removes issue of items such as drinks, etc., sliding off current airplane trays, which are both out of reach and unrealistic for smaller people to maneuver.
Sports practices, events, bleachers.
Errands: Can even be used in a shopping cart.
Daily Commute
Hospital Beds (ideal for weakened, ill children who needs easy access to activities, their meals, technology, etc., allows contents to be closer to their bodies and removes issue of spilling and falling off a flat, non-recessed surface.)
Restaurants: Insert kits work with table or solo use configurations.
National Emergency or Crisis Scenarios: During major situations, storms or other incident whereas a large number of families seek shelter in a generic stadium or location. The product is lightweight and can be provided to families to enhance their experience and emergency residency.

Accordingly, it is to be understood that the implementations of the invention herein described are merely illustrative of the application of the principles of the invention. Reference herein to details of the illustrated implementations is not intended to limit the scope of the claims, which themselves recite those features regarded as essential to the invention.

1. A modular, portable, content delivery system, comprising:
a portable table, the table including:
a base;
a table top on the base, the table top including a recessed center section and configured to be supported on, around, or over a user's lap;
at least one modular insert configured to fit within the recessed center section of the table top, the at least one modular insert configured to be releasably received in and attached to the table top, each at least one modular insert comprising a modular container having an enclosed interior with a removable lid; and
a plurality of activity kits, each activity kit configured to be contained within the enclosed interior of the modular container.

2. The system of claim 1 wherein the system includes a plurality of accessories and the base includes a skirt, the skirt having a plurality of attachment points structured to enable releasable attachment of the plurality of accessories.

3. The system of claim 2 comprising a tether configured to attach one or more accessories to one of the plurality of attachment points on the skirt.

4. The system of claim 2 wherein the table top comprises a plurality of modular container recesses and wherein each modular container is sized and shaped to be removably and securely received within a respective modular container recess in the table top.

5. The system of claim 4 wherein each modular container recess of the plurality of modular container recesses has a unique geometric shape and each corresponding modular container has a matching geometric shape that is sized to be slidably engaged within the respective modular container recess.

6. The system of claim 1 wherein the base is configured to be attached to at least one of a seat, a stroller, and a tray.

7. The system of claim 2 further comprising at least one slot formed in the base and configured to receive a security strap.

8. The system of claim 2, comprising a carrying case sized and shaped to receive and hold the portable table and at least one activity kit.

9. The system of claim 8, wherein the skirt is configured to be foldable.

10. The system of claim 2 wherein the at least one modular insert and the plurality of modular containers are customizable by a user to enable a user to select contents for the at least one modular insert and the plurality of modular inserts.

11. The system of claim 2, wherein the at least one modular insert comprises an activity and entertainment module that contains a writing board and at least one writing utensil, the writing board configured to fold out from a lid of the modular insert and have one end supported on a lip on the modular insert.

12. The system of claim 2 wherein the base is a one-piece molded shell and formed from non-toxic, solid but flexible, washable, solvent and dishwasher safe plastic material.

13. The system of claim 2 comprising a retaining member for attachment to the portable table and placement behind a user to retain the portable table in a position in front of the user.
